(19) United States
(12) Patent Application Publication
(10) Pub. No.: US 2008/0231528 A1
(43) Pub. Date: Sep. 25, 2008

(54) Cavity Antenna Excited with One or Several Dipoles

(76) Inventor: Ramon Guixa Arderiu, Madrid (ES)

Correspondence Address: BIRCH STEWART KOLASCH & BIRCH, PO BOX 747, FALLS CHURCH, VA, 22040-0747, US

(21) Appl. No.: 10/586,164

(22) PCT Filed: Apr. 25, 2005
(86) PCT No.: PCT/EP2005/070051

§ 371 Date: Jul. 14, 2006

(51) Int. Cl. H01Q 1/00; H01Q 9/16

(52) U.S. Cl. 343/749; 343/810

(57) ABSTRACT

Cavity antenna excited with one or several dipoles in a single piece, which has on the element that excites the cavity a metallic plate connected to earth and which allows the input impedance of the antenna to be adjusted as well as the reflections in the radome, by means of the adjustment of the distance with respect to the back wall of the cavity, avoiding through the connection to earth that the antenna becomes charged electrostatically. The cavity assembly and the metallic plate allow a broader bandwidth, moreover a simpler control is achieved in the adjustment of the level of crosspolar polarization, as well as of the decoupling between dipoles by modification in the shape of the metallic plate. The grouping of the antennas in an array is possible in an immediate manner with no need to alter the size or shape of the cavities or of the dipoles which excite said cavities.

### OBJECT OF THE INVENTION

An object of the present invention is a cavity-backed antenna excited with one or several dipoles in a single piece.

Antennas with dipoles are employed, among other applications, in the construction of base stations for mobile communications.

The present invention is characterized in the special configuration and design of the antenna, in such a way that it is possible to adjust the input impedance of the antenna without the need to modify any of the characteristics of the dipole or dipoles nor of the cavity, which is achieved by adjusting merely the distance at which a metallic plate is welded to the base of the element which excites the cavity and adjusting the size of said plate.

The present invention is also characterized in that through the metallic plate being connected to earth electrically the antenna it is not charged electrostatically.

It is also an object of the invention to provide a cavity antenna which allows an array to be assembled formed by cavity antennas like that of the invention without the need to vary the size or form of the cavities or of the dipoles of said antennas.

In addition, in an array formed exclusively by cavity antennas like that of the present invention, it is possible to adjust the input impedance of the array in a simple manner, as well as the isolation between ports corresponding to different polarizations and the level of crosspolar polarization, and to suppress part of the reflections that occur in the radome.

Thus, the present invention lies within the ambit of cavity antennas excited with dipoles.

### BACKGROUND OF THE INVENTION

Wireless communication systems suffer the effects of fading caused by the so-called multipath effect.

In certain applications cavity antennas are usually used because they have good frequency performance, that is, they have a broad bandwidth, and they are easy to construct.

An example of cavity antenna employment is to be found in the U.S. Pat. No. 3,740,754 A, published on Jun. 6, 1973, wherein a circular cavity excited with a pair of crossed dipoles is shown.

The circular cavities excited by crossed dipoles have habitually been used to radiate circular polarization, achieving a good axial ratio as well as a relatively broad bandwidth, and they have been used extensively in broadcasting.

In general, the cavities are usually excited with dipoles, patches or slots.

Dipoles are very well-known in the telecommunications industry, among which are found the half wavelength dipoles of the bowtie or butterfly type.

For example, in U.S. Pat. No. 6,025,798 A, published on Feb. 15, 2000, a crossed dipole is presented formed by two pairs of arms arranged in a V-shape, which is fastened to a reflector plane and the radiation from which takes place in two mutually orthogonal polarizations. The V-shape formed by the dipoles is used for its greater bandwidth with respect to linear dipoles.

Also, in the patent U.S. Pat. No. 6,747,606 B2 published on Jun. 8, 2004 an antenna is shown formed by a series of butterfly type crossed dipoles, which have dual polarization, the dipoles being mounted on a reflector.

However in this type of antenna it is difficult to adjust the input impedance, as well as to carry out modifications of the same once built.

In addition, in this type of antenna and array formed based on this type of antenna, nor is it simple to modify or adjust the level of crosspolar polarization, and to reduce in a simple manner the coupling between dipoles.

Another drawback of the State of the Art antennas is that the grouping thereof to form arrays is not immediate, instead it is necessary to vary the physical characteristics, form and/or size, of the different elements in the array, which complicates and makes more expensive their assembly and erection.

Still another drawback of the state of the art antennas is that the adjustment of the input impedance to the dipoles is carried out by means of transformers or with lengths of cable of different characteristic impedances or by partly modifying the characteristics of standard cables, which complicates and makes more expensive their assembly and erection.

Therefore, the objective of the present invention is to overcome the aforementioned drawbacks wherein a broadband cavity antenna excited by a dipole or dipoles is obtained, with which:
It is possible to change the input impedance of the antenna easily,
The level of crosspolar polarization and the isolation level between dipoles can be controlled and adjusted in a simple way,
It allows said antennas to be mounted in array in an immediate manner without the need for any modification in size or form of the same,
It allows the adjustment of impedance, level of crosspolar polarization and isolation between dipoles of the same cavity antenna and between dipoles belonging to different cavities in an array, formed by antennas like that of the invention, in a simple manner,
It improves the bandwidth, isolation between dipoles and level of crosspolar polarization,
It allows the connection of standard coaxial cable directly at the input of the dipoles, without the need to insert transformers, lengths of cable of different characteristic impedance or carry out any modification in said cables to adjust the input impedance,
It improves the physical behaviour of the structure of an array of antennas with respect to weather conditions.

### DESCRIPTION OF THE INVENTION

The present invention provides a new antenna suitable for use, among others, in arrays located in base stations for mobile communications.

The antenna is formed in a cavity and is excited by means of one or several dipoles, it being possible, in the case of having two crossed dipoles, to transmit or to receive in two mutually orthogonal linear polarizations.

The adjustment of the input impedance of the antenna is achieved based on modification to the distance at which a metallic plate is placed over the dipole or dipoles and adjusting the size of said plate, without the need to modify any characteristic of the dipole or dipoles nor of the cavity.

The cavity together with the metallic plate facilitate a broadband performance with respect to a single dipole or isolated dipoles.

The dipole or dipoles are obtained in a single piece. In the case of exciting the cavity by means of two broadband crossed dipoles, this single piece has four pairs of arms, the pairs of arms having a V-shaped or U-shaped configuration, the arms being arranged in a radial manner outwards from a centre vertex or point.

All the pairs of arms are joined in a base piece, at an approximate distance of λ/4, which is that employed for fixing the dipoles to the cavity.

The opposing pairs of arms are joined by means of a coaxial cable, the screen being connected to one of the pairs of arms and the centre conductor to the opposing pair of arms, and positioned in the cavity so that the antenna can transmit or receive signals according to two orthogonal linear polarizations.

The object of the invention is not limited by the number of pairs of arms whereby it would change the polarization possibilities.

In order to be able to adjust the input impedance of the antenna, on the top part of the pairs of arms of the dipole or dipoles a metallic plate is mounted which is fixed to their base, to the cavity or any other element connected to earth.

The adjustment of the impedance is achieved by the adjustment of the distance at which the metallic plate is fixed to the back earth plane of the cavity and by adjusting the size of the plate. Through this variation in the distance it is not necessary to modify any characteristic either of the dipoles or of the cavity.

Another effect arising from the employment of the metallic plate connected to earth, besides allowing the adjustment of the impedance, is that it avoids the antenna becoming charged electrostatically.

In addition, the metallic plate allows the partial suppression of the reflections which are produced on the protective hood of the antenna or antenna array, this hood being also known as the radome.

With the different forms of the metallic plate it is possible to adjust in a simple manner the level of crosspolar polarization and the decoupling between dipoles. As well as adjusting the level of crosspolar polarization, in an antenna array like that of the invention a better control is achieved of the isolation between ports and decoupling between dipoles. The reason for this effect is that if the form of the metallic plate is not perfectly symmetrical both the crossed dipoles are coupled to each other and the dipoles belonging to other radiating elements of the array. By appropriately adjusting the forms of the metallic plates of the elements of the array, a cancellation is substantially achieved of all the couplings, whereby the isolation at the input of the array is very good. This principle is that which is also used to partially suppress the reflections produced in the radome of the array.

In addition, the decoupling between dipoles belonging to different individual antennas like those of the invention in an array and the level of crosspolar polarization is improved by modifying the profiles and/or the heights of the side walls of the cavity. Also, by adjusting the profiles and the heights of the side walls of the cavity as well as the dimensions of the cavity different radiation patterns are formed, with different characteristics such as main beam width or level of main lobe to secondary for example.

For example in the case of using a rectangular cavity, by narrowing or widening one of the dimensions of the cavity, a widening or narrowing respectively is achieved in the main lobe of the radiation pattern in the plane perpendicular to the back wall of the cavity and parallel to said dimension.

The fixing of the metallic plate is done with some rods, which can run through the space between the pairs of arms.

On the base of the dipole or dipoles in a single piece there are some recesses which facilitate the entry of a coaxial cable which runs through the interior space of two arms.

Each of the opposing pairs of arms has some opposing perforations the object of which is to facilitate the connection between the pairs of arms by means of coaxial cable. The perforations for connection between opposing arms can be arranged at a different level in each dipole, the object being to facilitate the interconnection of the arms of the different dipoles which excite the cavity.

The use of the metallic plate allows the adjustment of the input impedance of the antenna whereby standard coaxial cable can be connected directly to the input of the dipoles, without the need to insert transformers, lengths of cable of different characteristic impedance or to carry out any modification in said cables to adjust the input impedance.

Moreover, cavity antennas like that of the invention, can be grouped to form arrays in a simple and immediate manner, that is, without the need to modify either the form or the size of the cavities or the dipole or dipoles which excite them.

Even so, to be able to form different radiation patterns, it is possible to group antennas like those of the invention with cavities of different size, form or profile or height of their side walls.

Furthermore, the arrangement of the cavity antennas like those of the invention in an array can improve their performance:
If small rods or metal strips are welded on the metallic plate in one or more dipoles of the array a better reception is achieved of the signals received from the side, the effect of polarization misalignment being offset with the aforementioned rods or strips.
The reflections that are produced in the protective enclosure of the antenna (radome) against the weather, as well as the coupling between dipoles and overall level of crosspolar polarization of the array, are suppressed partially by setting the metallic plates over the different dipoles to determined distances and modifying the shape of the metallic plates.
By modifying the size, the profiles of the side walls of the cavity and their height as well as the size of the cavity, it is possible to improve still more the decoupling between dipoles, level of crosspolar polarization and the radiation pattern.

Finally with the object of avoiding deformations due to changes in temperature, the cavities and the whole metallic structure of the array in the event, are manufactured in steel, with an electrolytic plating, while the radome is made of glass fiber with polyester. The electrolytic plating can be of copper and white brass.

### EXPLANATION OF THE DRAWINGS

To complete the description that will be made hereunder and with the object of assisting in a better understanding of its characteristics, the present descriptive specification is accompanied with a set of drawings in the figures of which, by way of illustration and not restrictively, the most significant details in the invention are represented.

FIG. 1 shows a representation of a rectangular back cavity antenna excited by a pair of broadband crossed dipoles.

FIG. 2 shows a representation of the bottom view, of a side elevation and the plan view of the two broadband crossed dipoles in a single piece with the metallic plate which together with the cavity form an embodiment of the antenna object of the invention.

FIG. 3 is a representation of the cross section taken of the two broadband crossed dipoles in a single piece with the metallic plate at the plane III-III.

FIG. 4 likewise shows the cross section taken of the two broadband crossed dipoles in a single piece with the metallic plate at the plane IV-IV and perpendicular to the preceding plane III-III.

FIG. 5 shows the cross section taken of the two broadband crossed dipoles in a single piece with the metallic plate at the plane V-V.

### PREFERRED EMBODIMENT OF THE INVENTION

In the light of the foregoing figures a preferred mode of embodiment of the invention is described below together with the explanation of the drawings.

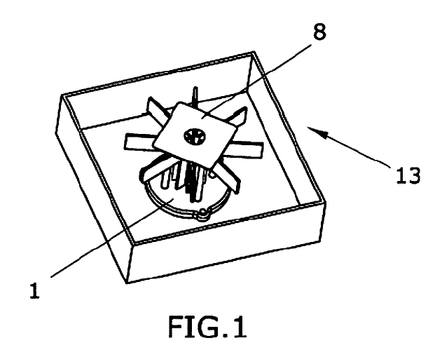

In FIG. 1, a cavity antenna can be observed like that which is object of the invention, excited by a pair of broadband crossed dipoles in a single piece, said piece is housed in a square cavity (13) and fixed by its base (1) to the cavity (13).

By narrowing or widening one of the dimensions of the cavity, therefore making the cavity rectangular, a broadening or narrowing is achieved respectively of the main lobe of the radiation pattern in the plane perpendicular to the back wall of the cavity and parallel to this dimension.

On the pair of crossed dipoles a metallic plate (8) is mounted which is fixed to the base of the dipoles by welding, said base being connected to earth whereby the antenna does not become charged electrostatically.

This metallic plate (8) is what will allow the adjustment of the input impedance of the antenna by means of adjustment of the distance at which said metallic plate (8) is welded to the earth plane and the adjustment of its size, no modification being necessary either in the dipoles or in the cavity to adjust its impedance.

The height of the four side walls of the cavity, in this particular case, is the same as the height at which the metallic plate is located, the element which excites the cavity being located totally inside the volume defined by the cavity.

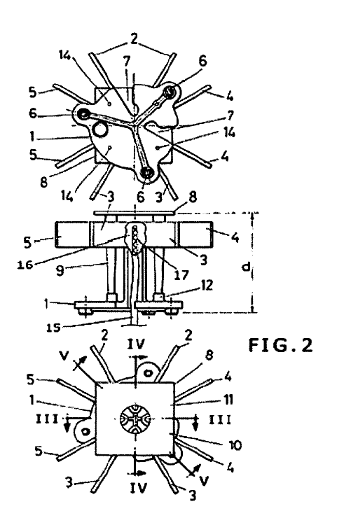

In FIG. 2, the bottom view, the elevation and the plan view are observed of the pair of dipoles which are housed in a cavity, it being possible to have one or several dipoles, and in the event of being two crossed dipoles like those shown to transmit or to receive according to two mutually orthogonal polarizations.

The single piece which forms the dipoles has a base element (1) from which four arm pairs (2), (3), (4) and (5) emerge, each pair of arms having a U-shaped or V-shaped configuration, with the arms arranged radially outward from a centre point.

On the base there is a number of perforations (6) made which are threaded internally. Also, it has a series of recesses (7) which serve for the entry of the coaxial cables (15) which are connected directly to the opposing arm pairs. These coaxial cables (15) can have a standard characteristic impedance and are joined to the input of each of the two dipoles by an application of solder (16) applied directly on the screen (17) of the coaxial cable (15) in one of the pairs (3) of arms, and on the centre conductor of the coaxial cable (15) in the other pair of arms (2) of the same dipole. It can be observed that impedance transformers are not used, nor lengths of cable of different characteristic impedances since the adjustment of input impedance of the antenna is carried out with the metallic plate.

It is likewise observed that over the top part of the arms a metallic plate (8) is mounted connected and held to the base of the dipole by four rods (9) at a distance less than λ/2, where λ is the wavelength of the centre frequency of the working band.

Said metallic plate (8) is located at a distance “d” from the back wall of the cavity on which the dipoles are secured and it is electrically connected to earth. Depending on said distance “d” and on the size of the metallic plate (8), it is possible to adjust the input impedance of the antenna without the need to modify any of the characteristics of the dipoles or of the cavity.

The metallic plate (8) is supported by four rods (9), which at their bottom end (12) are housed in some expansions or bosses wherein the bottom end of the rods (9) are housed, it being observed in the bottom view that there are some small perforations (14) on the base is through which the securing of the ends of the rods can be carry out by welding.

The top end of the rods (9) is directly welded on the metallic plate (8). The rods (9) run through the space between each pair of adjacent arms.

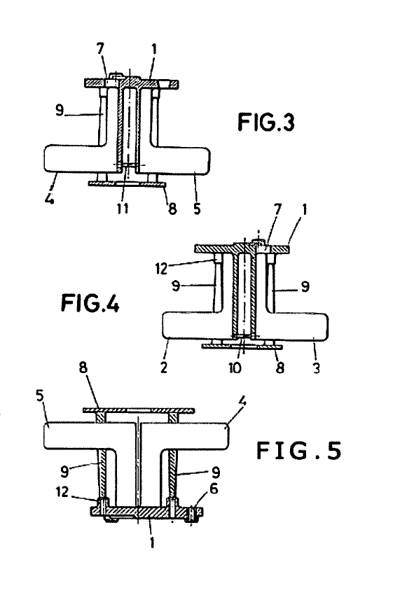

In FIG. 3, where the section at the plane III-III is shown, the opposing interconnection (11) is pointed out on the vertex of the pairs of opposing arms (4) and (5), which allows the electrical interconnection of the dipole constituted by the two pairs of opposing arms (4) and (5). This interconnection (11) is implemented at a level above the interconnection (10) implemented on the other dipole, this dipole being incorporated by the pair of opposing arm pairs (2) and (3) shown in FIG. 4.

The cavity has a rectangular or square form and together with the metallic plate facilitate a broadband performance with respect to a single dipole or isolated dipoles.

The dipoles are obtained in a single piece. With the different forms of the metallic plate it is possible to adjust in a simple way the level of crosspolar polarization, and obtain a better control of the isolation between ports and decoupling between dipoles. In addition with the distance of the metallic plate to the base of the dipole or dipoles, the reflections are partially suppressed that are produced at the radome.

It is not considered necessary to expand this description further for any expert in the matter to comprehend the scope of the invention and the advantages obtained from the same.

The materials, form, size and arrangement of the elements can suffer variation provided the essential nature of the invention is not altered.

The terms in which this specification has been written are always to be taken in the broadest sense and not restrictively.

1. Cavity antenna excited by one or several dipoles in a single piece, where the antenna is formed by a cavity in which this single piece is secured comprising one or several dipoles, characterized in that the antenna has a metallic plate mounted on an element which excites the cavity (the dipole or the dipoles), said plate being secured and connected electrically to the base of said excitation element in a single piece, to the cavity or to any other element connected to earth.

2. Cavity antenna excited by one or several dipoles in a single piece according to claim 1, characterized in that the metallic plate is secured at a distance less than λ/2 with respect to the back wall of the cavity, where λ is the wavelength of the centre frequency of the working band.

3. Cavity antenna excited by one or several dipoles in a single piece according to claim 2, characterized in that the metallic plate mounted on the element which excites the cavity is located at a distance “d” with respect to the back wall of the cavity, which allows the input impedance of the antenna to be adjusted, based on the modification of the distance “d”, without the need to modify any characteristic of the element which excites the cavity or of the cavity, as well as the partial suppression of the reflections which are produced in the radome.

4. Cavity antenna excited by one or several dipoles in a single piece according to claim 1, characterized in that at the input of the dipoles the connection of standard coaxial cable is carried out directly, without the need to interpose transformers, lengths of cable of different characteristic impedance or carry out any modification in said cables to adjust the input impedance of the antenna.

5. Cavity antenna excited by one or several dipoles in a single piece according to claim 2, characterized in that with different geometric forms of the metallic plate, it is possible to control and adjust in a simple manner the level of crosspolar polarization and the decoupling between dipoles.

6. Cavity antenna excited by one or several dipoles in a single piece according to claim 2, characterized in that the metallic plate is secured on the element which excites the cavity by means of rods.

7. Cavity antenna excited by one or several dipoles in a single piece according to claim 6, characterized in that to house the bottom end of the rods on the base of the element which excites the cavity some expansions or bosses emerge.

8. Cavity antenna excited by one or several dipoles in a single piece according to claim 1 characterized in that on the metallic plate of one or more antennas like those of the invention in an array of said antennas a small bar or metal strip can be mounted whereby a better reception is achieved of the signals which are received from the side, the misalignment effect of the polarization due to the lateral application of the signals at the antenna being offset with the aforementioned bars and strips.

9. Cavity antenna excited by one or several dipoles in a single piece according to claim 8, characterized in that by adjusting the distances at which the metallic plates are placed from the antennas in an array of said antennas, it is possible to suppress partially the reflections which are produced on the protective enclosure of the antenna or radome.

10. Cavity antenna excited by one or several dipoles in a single piece according to claim 2, characterized in that the cavity is manufactured in steel and plated electrolytically while the protective layer of the antenna or radome is fabricated in glass fibre with polyester.

11. Cavity antenna excited by one or several dipoles in a single piece according to claim 10, characterized in that the electrolytic plating is in copper and white brass.

12. Cavity antenna excited by one or several dipoles in a single piece according to claim 8, characterized in that in an array of said antennas all the cavities and the elements which excite them are identical.

13. Cavity antenna excited by one or several dipoles in a single piece according to claim 1 characterized in that the whole structure of an array, consisting of an array of antennas like that of the invention, is manufactured in steel and plated electrolytically while the radome is fabricated in glass fibre with polyester.

14. Cavity antenna excited by one or several dipoles in a single piece according to claim 13, characterized in that the electrolytic plating is in copper and white brass.

15. Cavity antenna excited by one or several dipoles in a single piece according to claim 1 characterized in that by adjusting the profiles and the heights of the side walls of the cavity as well as the dimensions of the cavity different radiation patterns are formed, with different characteristics such as the main beam width or level of main lobe to secondary for example.

16. Cavity antenna excited by one or several dipoles in a single piece according to claim 1 characterized in that by modifying the size, the profiles of the side walls of the cavity and the height thereof as well as the size of the cavity, it is possible to improve even more the decoupling between dipoles and level of crosspolar polarization.

17. Cavity antenna excited by one or several dipoles in a single piece according to claim 2 characterized in that on the metallic plate of one or more antennas like those of the invention in an array of said antennas a small bar or metal strip can be mounted whereby a better reception is achieved of the signals which are received from the side, the misalignment effect of the polarization due to the lateral application of the signals at the antenna being offset with the aforementioned bars and strips.

18. Cavity antenna excited by one or several dipoles in a single piece according to claim 3 characterized in that on the metallic plate of one or more antennas like those of the invention in an array of said antennas a small bar or metal strip can be mounted whereby a better reception is achieved of the signals which are received from the side, the misalignment effect of the polarization due to the lateral application of the signals at the antenna being offset with the aforementioned bars and strips.

19. Cavity antenna excited by one or several dipoles in a single piece according to claim 4 characterized in that on the metallic plate of one or more antennas like those of the invention in an array of said antennas a small bar or metal strip can be mounted whereby a better reception is achieved of the signals which are received from the side, the misalignment effect of the polarization due to the lateral application of the signals at the antenna being offset with the aforementioned bars and strips.

20. Cavity antenna excited by one or several dipoles in a single piece according to claim 5 characterized in that on the metallic plate of one or more antennas like those of the invention in an array of said antennas a small bar or metal strip can be mounted whereby a better reception is achieved of the signals which are received from the side, the misalignment effect of the polarization due to the lateral application of the signals at the antenna being offset with the aforementioned bars and strips.
